(19) United States
(12) Patent Application Publication
(10) Pub. No.: US 2025/0102755 A1
(43) Pub. Date: Mar. 27, 2025

(54) FIBER PANEL WITH COVERED CABLE STORAGE AND SPLICE OR ADAPTER AREA STRUCTURALLY CONFIGURED TO PROVIDE DIFFERENT PANEL CONFIGURATIONS DURING OPERATION

(71) Applicant: PPC BROADBAND, INC., East Syracuse, NY (US)

(72) Inventors: Stefan DONCHEV, Milton Keynes (GB); Manuel HEGER, East Syracuse, NY (US); Afzal V. ABDULSALAM, Edathala (KL) (IN)

(73) Assignee: PPC BROADBAND, INC., East Syracuse, NY (US)

(21) Appl. No.: 18/893,363

(22) Filed: Sep. 23, 2024

Related U.S. Application Data
(60) Provisional application No. 63/604,237, filed on Nov. 30, 2023.

(30) Foreign Application Priority Data
Sep. 22, 2023 (IN) 202321063661

(51) Int. Cl. G02B 6/44

(52) U.S. Cl. CPC G02B 6/4452; G02B 6/4454

(57) ABSTRACT

A fiber cable distribution panel that may be structurally configured to provide enhanced panel configurations on a mounting rack. The panel may include a main portion configured to be coupled with a mounting rack; a cable storage portion that may configured to be coupled with the main portion; a cable management portion that may be configured to be located in an interior of the cable storage portion; and a fiber connection portion that may be configured to be located in the interior of the cable storage portion. The body portion and the cable storage portion may be configured to permit the cable management portion to receive an additional slack length of a fiber optic input cable while the fiber optic input cable is coupled with the fiber connection portion so as to provide slack cable storage in the interior of the cable storage portion when relocating of the panel to a different position on the mounting rack.

### CROSS-REFERENCE TO RELATED APPLICATIONS

This application claims the benefit of Indian Provisional Patent Application No. 202321063661, filed Sep. 22, 2023, and U.S. Provisional Application No. 63/604,237 filed Nov. 30, 2023, which are currently pending, the disclosures of which are hereby incorporated by reference herein in their entireties.

### BACKGROUND

The present disclosure relates generally to cable management and, in particular, to optical fiber stub overlength storage in a moveable panel that also has an interchangeable area for splices or adapters.

Telecommunications and other systems include optical fiber cables that are split and/or spliced in panels that are mounted in racks that are in turn mounted in cabinets in a data room. It is desirable to be able to move a panel from one rack or cabinet to another rack or cabinet with a fiber stub connected to the panel.

### SUMMARY

The present disclosure provides a much-needed standard length stubbed splitter panel, which can be moved anywhere in a data room, without the problem of finding a solution for the stub overlength slack storage and that has an area for splices or adapters.

Embodiments provide a rack mountable panel, for example a one unit (1U) panel, stubbed with spliced or patched cable and internal storage for stub overlength. The storage in the panel allows the panel to be moved within the cabinet and/or data room, and extra cable stored inside and protected with a cover.

Embodiments provide a fiber cable distribution panel with covered cable storage and splice or adapter area structurally configured to provide different panel configurations during operation, including: a body portion that may be configured to be coupled with a mounting rack; a cable storage portion that may be structurally configured to be coupled with the body portion; a cable management portion that may be configured to be located in an interior of the cable storage portion; and a fiber connection portion that may be configured to be located in the interior of the cable storage portion. The cable storage portion may be structurally configured to pivot relative to the body portion between a closed position and an open position; the cable management portion may be structurally configured to receive a slack length of a fiber optic input cable; the fiber connection portion may be at least partially enclosed by the body portion and the cable storage portion when the cable storage portion is in the closed position; the cable management portion may be at least partially enclosed by the body portion and the cable storage portion when the cable storage portion is in the closed position; the fiber connection portion may be structurally configured to couple a fiber of the fiber optic input cable with an output fiber; the cable storage portion may comprise a fiber connector portion that may be structurally configured to optically couple an output fiber from the fiber connection portion with a fiber cable external to the fiber cable distribution panel; and the body portion and the cable storage portion may be configured to permit the cable management portion to receive an additional slack length of the fiber optic input cable or allow pay out of a portion of the slack length of the fiber optic input cable while the fiber optic input cable is coupled with the fiber connection portion so as to provide slack cable storage in the interior of the cable storage portion when relocating of the panel to a different position on the mounting rack.

In particular embodiments, the fiber connection portion may comprise an adapter that may be structurally configured to receive fiber connectors.

In particular embodiments, the fiber connection portion may comprise a splice area that may be structurally configured to hold fiber splices.

In particular embodiments, the cable storage portion may comprise a base and a wall extending from the base.

In particular embodiments, the base, the wall, and a portion of the body portion may form an enclosure.

In particular embodiments, the cable management portion may comprise a partition that may be structurally configured to receive the additional slack length of the fiber optic cable.

In particular embodiments, the connector holding portion may be structurally configured to hold a plurality of connectors that are connected to optical fibers contained in the fiber optic cable.

In particular embodiments, the optical fibers may be optically connected to the connectors.

Embodiments provide a fiber cable distribution panel with covered cable storage and splice or adapter area structurally configured to provide different panel configurations during operation, including: a main portion that may be configured to be coupled with a mounting rack; a cable storage portion that may be structurally configured to be coupled with the main portion; a cable management portion that may be configured to be located in an interior of the cable storage portion; and a fiber connection portion that may be configured to be located in the interior of the cable storge portion. The cable storage portion may be structurally configured to move relative to the main portion between a closed position and an open position; the cable management portion may be structurally configured to receive a slack length of a fiber optic input cable; the fiber connection portion may be at least partially enclosed by the main portion and the cable storage portion when the cable storage portion is in the closed position; the cable storage portion may comprise a fiber connector portion that is structurally configured to optically couple an output fiber from the fiber connection portion with a fiber cable external to the fiber cable distribution panel; and the body portion and the cable storage portion may be configured to permit the cable management portion to receive an additional slack length of the fiber optic input cable or allow pay out of a portion of the slack length of the fiber optic input cable while the fiber optic input cable is coupled with the fiber connection portion so as to provide slack cable storage in the interior of the pivoting portion when relocating of the panel to a different position on the mounting rack.

In particular embodiments, the cable storage portion may be configured to pivot relative to the main portion between the closed position and the open position.

In particular embodiments, the fiber connection portion may comprise an adapter that may be structurally configured to receive fiber connectors.

In particular embodiments, the fiber connection portion may comprise a splice area that may be structurally configured to hold fiber splices.

In particular embodiments, the cable storage portion may comprise a base and a wall extending from the base.

In particular embodiments, the base, the wall, and a portion of the main portion may form an enclosure.

In particular embodiments, the cable management portion may comprise a partition that may be structurally configured to receive the additional slack length of the fiber optic cable.

In particular embodiments, the connector holding portion may be structurally configured to hold a plurality of connectors that are connected to optical fibers contained in the fiber optic cable.

In particular embodiments, the optical fibers may be optically connected to the connectors.

Embodiments provide a fiber cable distribution panel with covered cable storage and splice or adapter area structurally configured to provide different panel configurations during operation, including: a main portion that may be configured to be coupled with a mounting rack; a cable storage portion that may be structurally configured to be coupled with the main portion; a cable management portion that may be configured to be at least partially located in an interior of the cable storage portion; and a fiber connection portion that may be configured to be at least partially located in the interior of the cable storage portion. The body portion and the cable storage portion may be configured to permit the cable management portion to receive an additional slack length of a fiber optic input cable or allow pay out of a portion of a slack length of the fiber optic input cable while the fiber optic input cable is coupled with the fiber connection portion so as to provide slack cable storage in the interior of the cable storage portion when relocating of the panel to a different position on the mounting rack.

In particular embodiments, the cable storage portion may be configured to move relative to the main portion between the closed position and an open position.

In particular embodiments, the cable storage portion may be configured to pivot relative to the main portion between the closed position and the open position.

In particular embodiments, the fiber connection portion may comprise an adapter that may be structurally configured to receive fiber connectors.

In particular embodiments, the fiber connection portion may comprise a splice area that is structurally configured to hold fiber splices.

In particular embodiments, the cable storage portion may comprise a base and a wall extending from the base, and the base, the wall, and a portion of the main portion form an enclosure.

In particular embodiments, optical fibers of the fiber optic cable may be optically connected to the connectors.

In particular embodiments, the cable management portion and the fiber connection portion may be at least partially enclosed by the main portion and the cable storage portion when the cable storage portion is in a closed position.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a perspective view of an exemplary finer panel in accordance with various aspects of the disclosure with fiber cables attached.

FIG. 2 is a perspective view of a first embodiment of an exemplary fiber panel in accordance with various aspects of the disclosure in a deployed state.

FIG. 3 is a top view of the embodiment of FIG. 2 in a deployed state.

FIG. 4 is a partial top view of the embodiment of FIG. 2 in a deployed state.

FIG. 5 is a perspective view of the embodiment of FIG. 2 in a deployed state.

FIG. 6 is a perspective view of a second embodiment of an exemplary fiber panel in accordance with various aspects of the disclosure in a deployed state.

FIG. 7 is a partial perspective view of the embodiment of FIG. 6.

FIG. 8 is a top view of the embodiment of FIG. 6 in a deployed state.

FIG. 9 is a perspective view of the embodiment of FIG. 6 in a deployed state.

FIG. 10 is a top view of an embodiment in a closed position.

FIG. 11 is a front view of the embodiment of FIG. 10 in the closed position.

### DETAILED DESCRIPTION OF EMBODIMENTS

Embodiments of the disclosure provide a fiber panel for fiber optic cable and includes an enclosure that provides a covered storage area for a loop of the fiber optic cable and a fiber connection portion that facilitates movement of the panel with the fiber optic cable in a connected state.

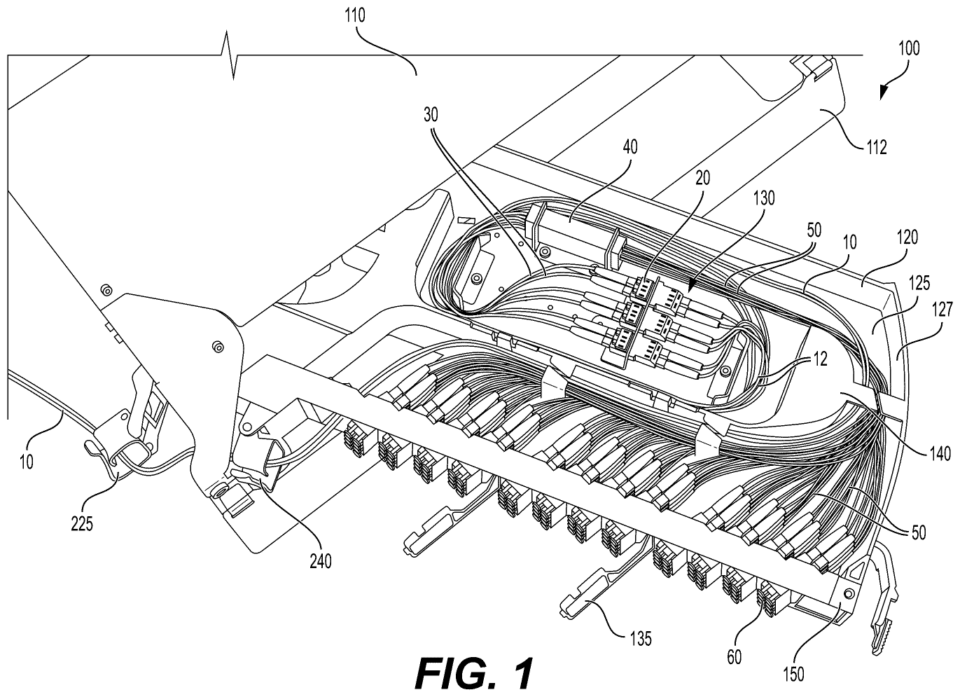

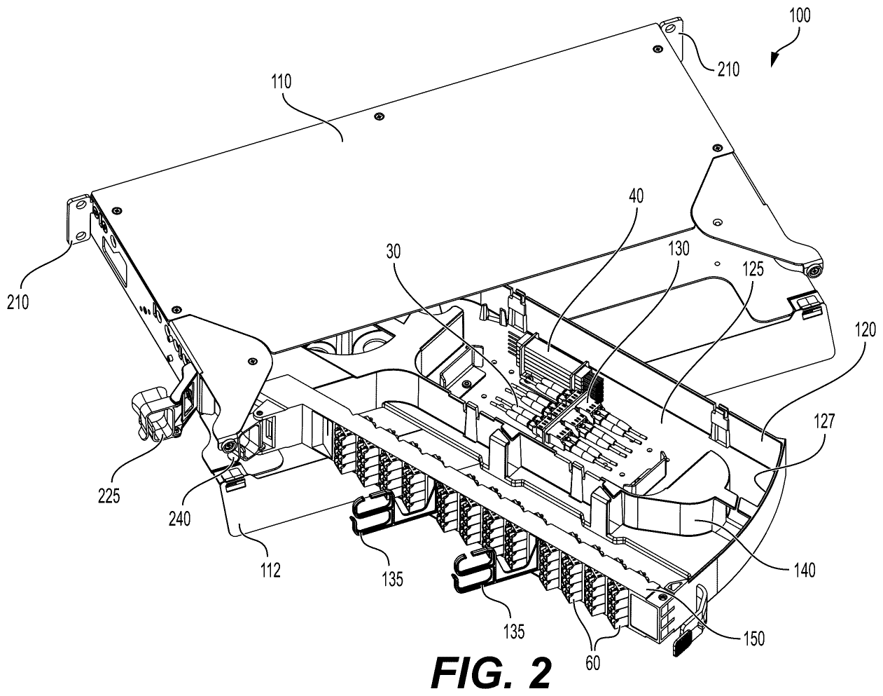

FIGS. 1 and 2 show an example of a panel 100 having a main portion, for example, a main body or boy portion, 110 and a moving portion, for example, a pivoting portion or a cable storage portion, 120. The pivoting portion 120 is, in this example, pivotingly attached to the main body 110 so that the pivoting portion 120 can move, for example, pivot, between a second position, for example, a deployed position (shown in FIG. 1) and a first position, for example, a closed position in which the pivoting portion 120 is at least partially inside the main body 110.

In the example shown in FIGS. 1 and 2, the main body includes a closure portion, for example, a door, 112 that is movable between an open position (shown in FIG. 1) and a closed position in which the pivoting portion 120 is hidden inside the main body behind the closed door 112. When the pivoting portion 120 is in the closed position, the elements and features on the pivoting body 120 (described below) are protected by the main body 110 and the door 112.

The pivoting portion 120 shown in FIGS. 1 and 2 has a base portion, for example, a base, 125 from which a perimeter portion, for example, a perimeter wall, 127 extends. In this example, the pivoting portion 120 has a connector holding portion 150 located at a first end, for example, a front, of the pivoting portion 120. The connector holding portion 150 is configured to hold a plurality of connectors 60. Also shown are two cable routing portions, for example, cable guides, 135 that extend from the connector holding portion 150. The cable guides 135 are configured to hold, for example, fiber optic cables that are connected to the connectors 60.

FIG. 1 shows an example of a cable 10 coming into the pivoting portion 120 and looping around a cable management portion 140. In this example, the cable 10 includes a plurality of fibers 12 that are removed from an outer jacket of the cable 10 and connected to one side of adapters 20 that are, in this example, part of a fiber connection portion 130. In this example, a plurality of fiber stubs 30 are connected at one end to an opposite side of the adapters 20. The other ends of the fiber stubs 30 are connected to, in this example, a splitter 40. A plurality of fibers 50 extend from the splitter 40 to the connectors 60 mounted in the connector holding portion 150. While the figures show a particular type of connector 60, it is noted that other types of connectors can be used with embodiments of the disclosure.

FIGS. 1 and 2 show a main body cable control portion 225 that extends from the main body 110. Also shown is a pivoting portion cable control portion 240 that extends from the pivoting portion 120. As shown in FIG. 1, the main body cable control portion 225 and the pivoting portion cable control portion 240 are configured to receive and restrain the cable 10 as it extends out of the pivoting portion 120 and beside the main body 110. FIG. 2 shows, in this example, two mounting portions, for example, mounting brackets, 210 that extend from the main body 110. The mounting brackets 210 are configured to be used to secure the main body 110 to a rack or cabinet.

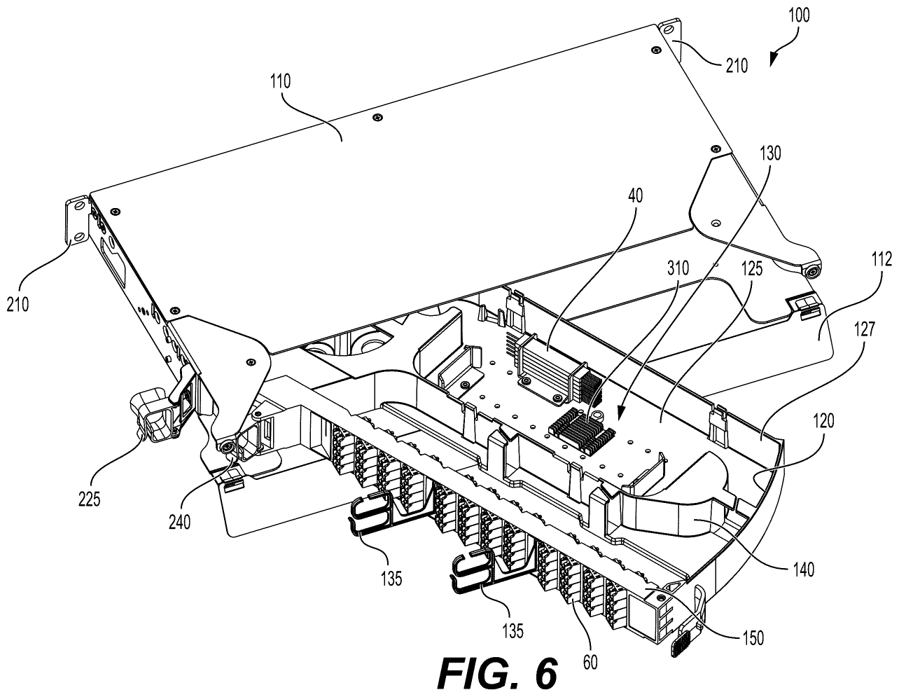

FIGS. 2-5 show an example of a first embodiment of the disclosure. FIGS. 6-9 show an example of a second embodiment of the disclosure. The only difference between the exemplary embodiments is the type of fiber connection portion 130 used. In FIGS. 2-5 (and in FIG. 1), the fiber connection portion 130 includes an adapter holder portion, for example, an adapter holder, 210 that receives one or more of the adapters 20. In FIGS. 6-9, the fiber connection portion 130 is a splice portion, for example, a splice area, 310.

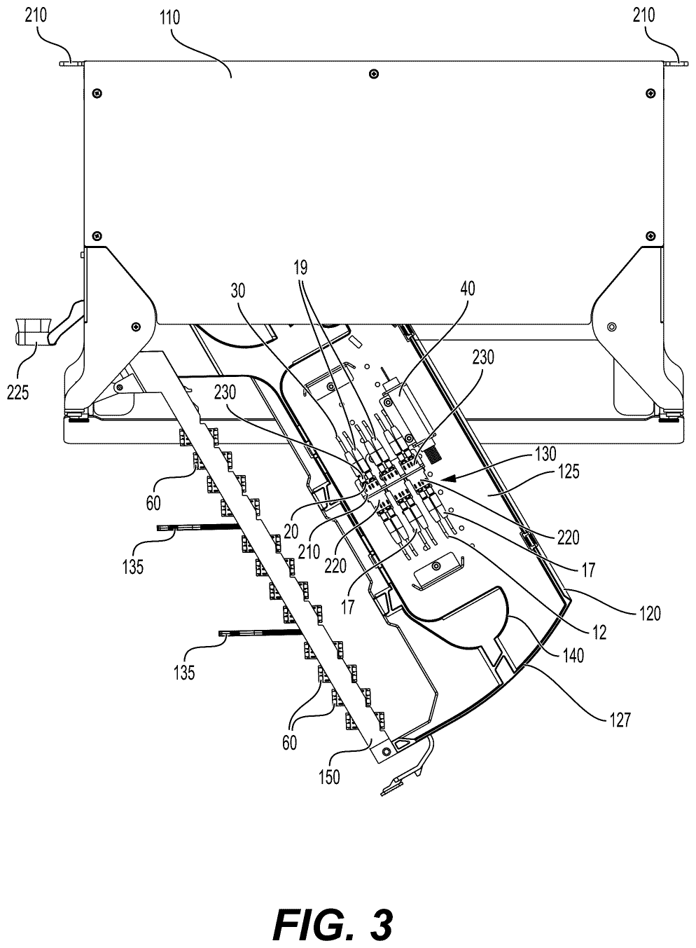

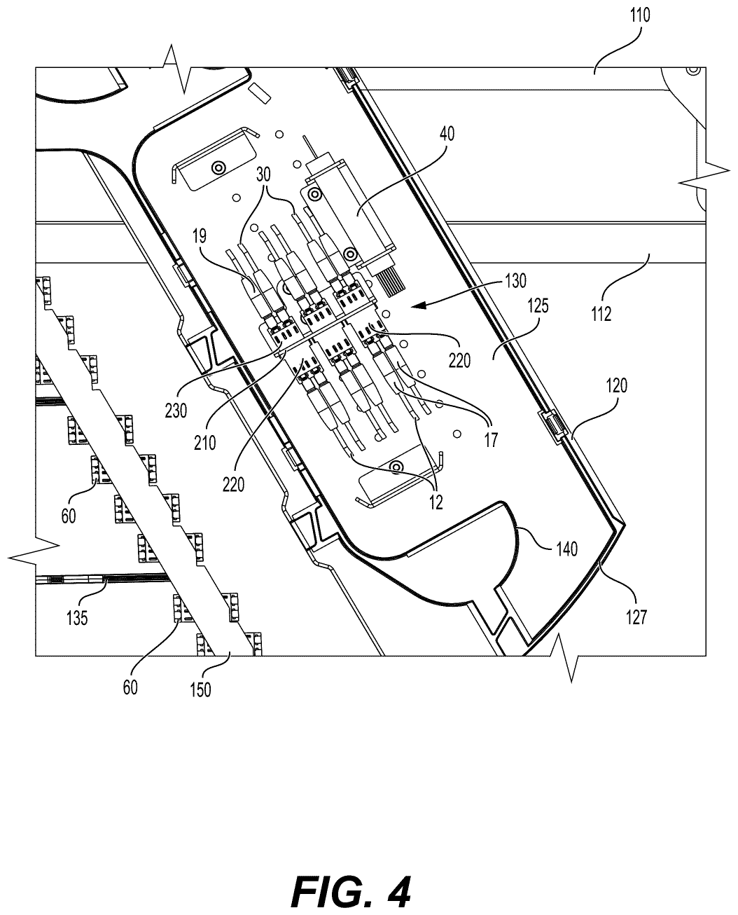

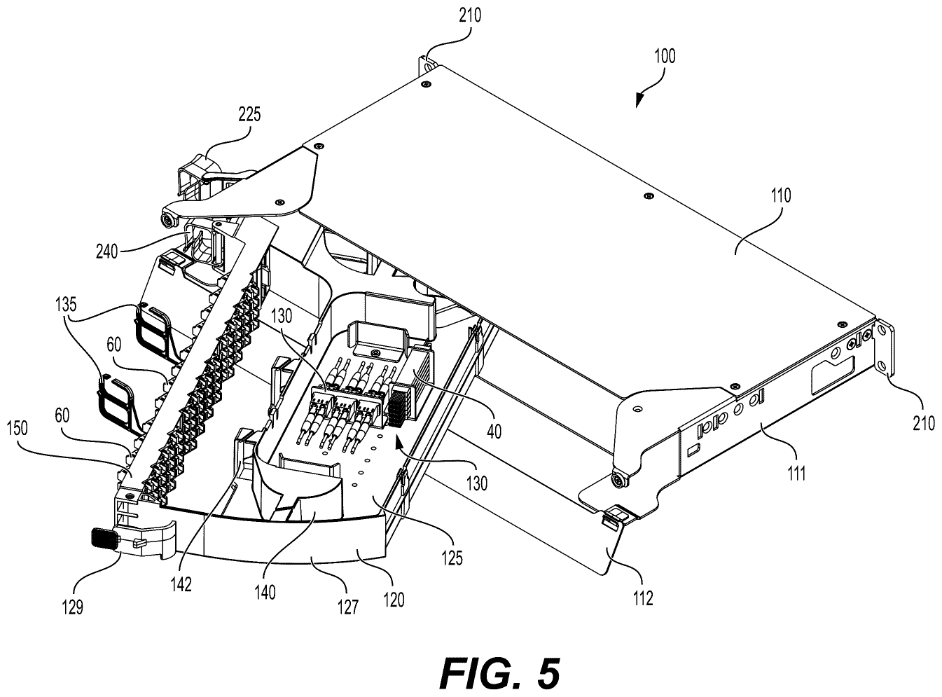

FIGS. 2-5 are shown without the cable 10 and fibers 50. In these FIGS., the fibers 12 and the fiber stubs 30 are shortened for clarity. FIG. 3 shows each of the fibers 12 being connected to a first side 220 of one of the adapters 20 by a fiber connector 17, and each of the fiber stubs 30 being connected to a second side 230 of one of the adapters 20 by a fiber connector 19. Other forms, sizes and/or types of fiber connectors and adapters can also be used. FIG. 4 is a magnified view of a portion of FIG. 3. FIG. 5 shows the cable management portion 140 in the form of a wall that partially surrounds the fiber connector portion 130. The cable management portion 140 can take other forms that also provide support for slack cable or a slack length of cable or one or more loops of the cable 10 and/or the fibers 50. FIG. 5 also shows the perimeter wall 127 being curved to allow the pivoting portion 120 to pivot into the main body 110. FIG. 5 shows a catch mechanism 129 that is configured to engage main body 110, for example, a side wall 111 of main body 110, to secure the pivoting portion 120 in the closed position.

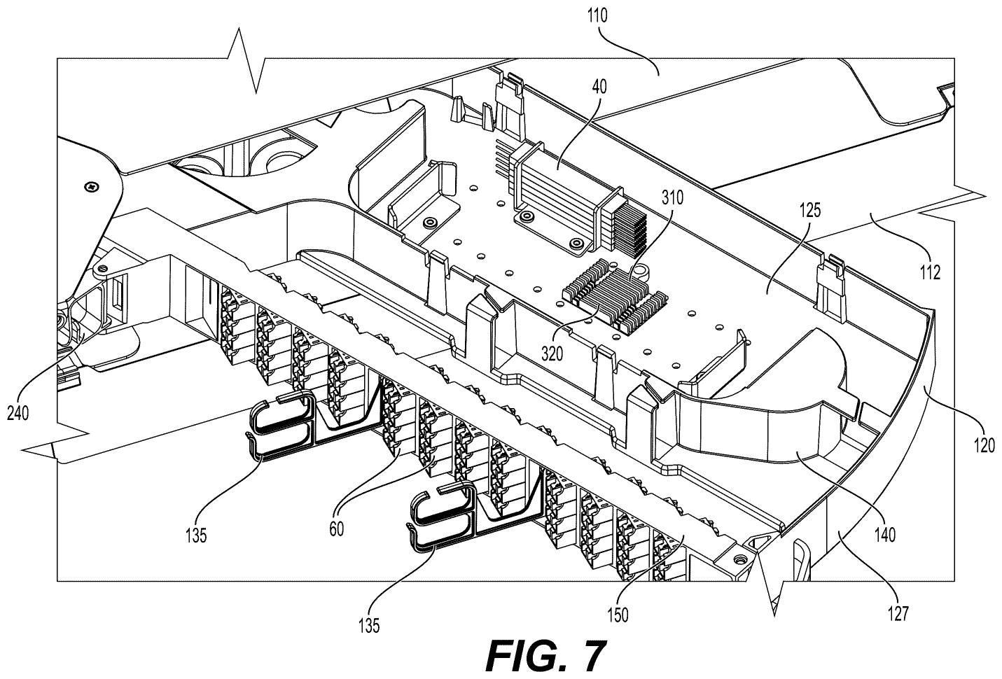

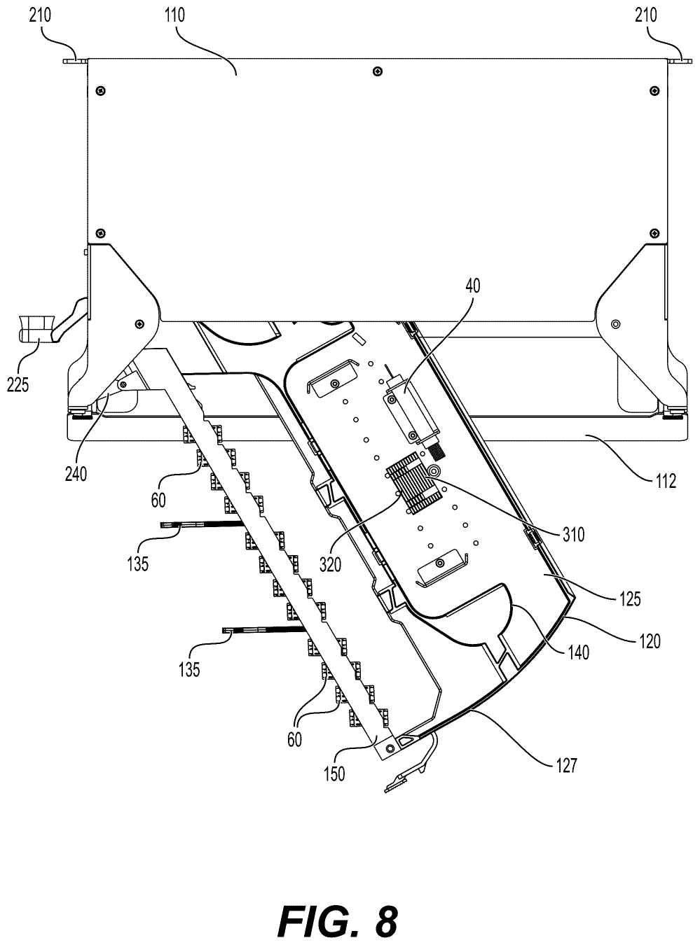

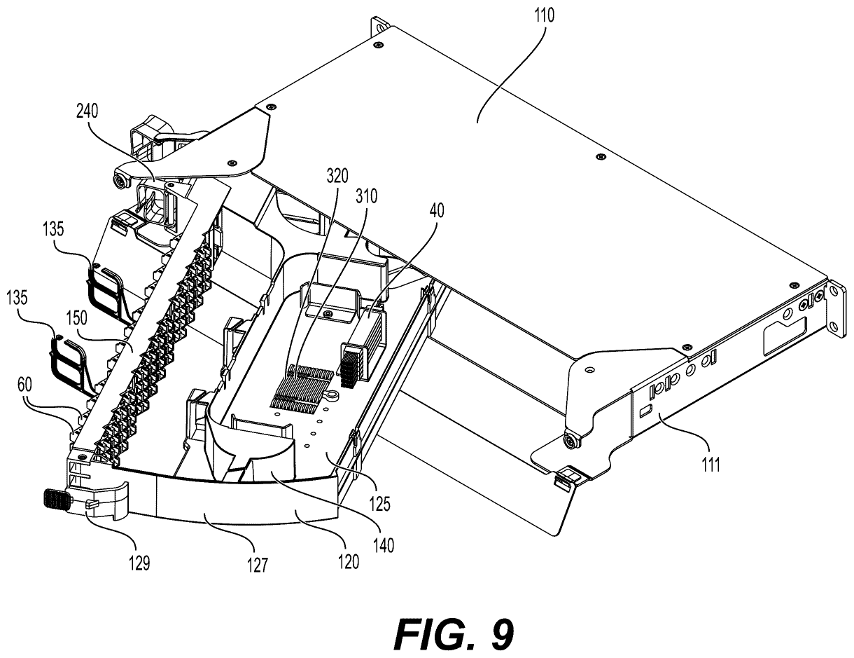

As stated above, FIG. 6 shows an embodiment in which the fiber connection portion 130 is a splice area 310. In this example, as show in FIG. 7, the splice area 310 includes a splice holder 320 that has a plurality of recesses, or grooves, that each are configured to hold a splice of a fiber. The splice area 310 can take other forms and/or shapes, and/or be different sizes. FIGS. 8 and 9 show the splice area 310 in its position relative to the splitter 40. Other locations and/or relative positions of the splice area and the splitter can be used.

The fiber connection portion 130 is interchangeable such that either the adapter holder 210 or the splice area 310, or another cable/fiber fearture, can be used depending on the needs of the particular installation.

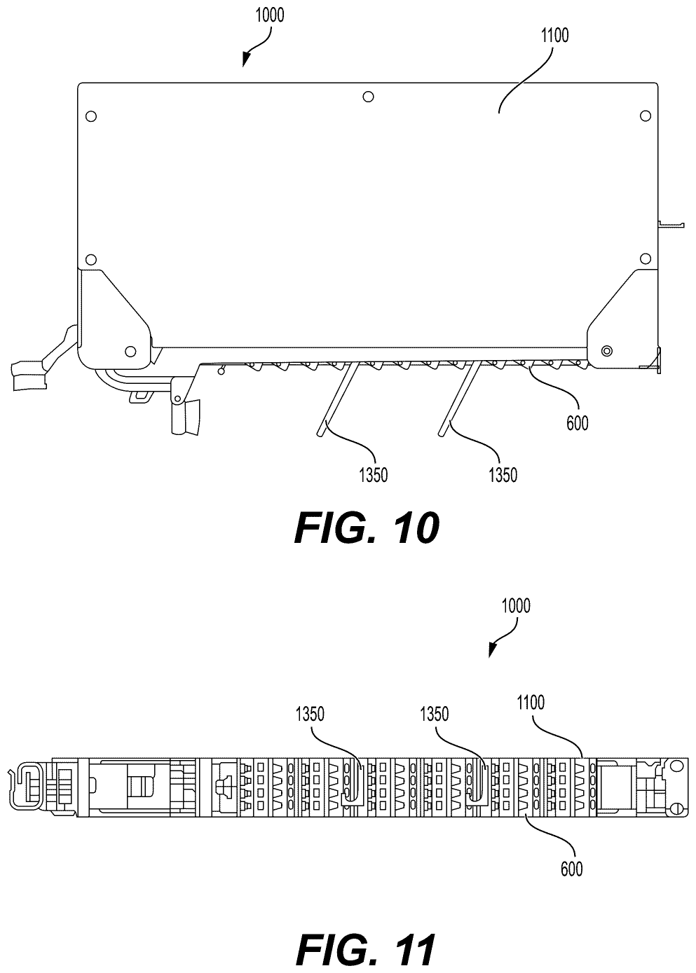

FIGS. 10 and 11 show a panel 1000 having a main portion, for example, a main body, 1100 and a moving portion, for example, a pivoting portion, 1200. The pivoting portion 1200 is, in this example, pivotingly attached to the main body 1100 so that the pivoting portion 1200 can move, for example, pivot, between a second position, for example, a deployed or open position (shown in FIG. 1) and a first position, for example, a closed position (shown in FIGS. 10 and 11) in which the pivoting portion 1200 is at least partially inside the main body 1100. The embodiments shown in FIGS. 1-9 are configured to pivot into the closed position shown in FIGS. 10 and 11.

FIGS. 10 and 11 show two cable routing portions, for example, cable guides, 1350 that extend from the connector holding portion. The cable guides 1350 are configured to hold, for example, fiber optic cables that are connected to connectors 600.

Although the exemplary embodiments are described separately herein, it is to be understood that various features and functions of one embodiment can apply to other embodiments.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A fiber cable distribution panel with covered cable storage and splice or adapter area structurally configured to provide different panel configurations during operation, comprising:
a body portion configured to be coupled with a mounting rack;
a cable storage portion structurally configured to be coupled with the body portion;
a cable management portion configured to be located in an interior of the cable storage portion;
a fiber connection portion configured to be located in the interior of the cable storage portion;
wherein the cable storage portion is structurally configured to pivot relative to the body portion between a closed position and an open position;
wherein the cable management portion is structurally configured to receive a slack length of a fiber optic input cable;
wherein the fiber connection portion is at least partially enclosed by the body portion and the cable storage portion when the cable storage portion is in the closed position;
wherein the cable management portion is at least partially enclosed by the body portion and the cable storage portion when the cable storage portion is in the closed position;
wherein the fiber connection portion is structurally configured to couple a fiber of the fiber optic input cable with an output fiber;
wherein the cable storage portion comprises a fiber connector portion that is structurally configured to optically couple an output fiber from the fiber connection portion with a fiber cable external to the fiber cable distribution panel; and
wherein the body portion and the cable storage portion are configured to permit the cable management portion to receive an additional slack length of the fiber optic input cable or allow pay out of a portion of the slack length of the fiber optic input cable while the fiber optic input cable is coupled with the fiber connection portion so as to provide slack cable storage in the interior of the cable storage portion when relocating of the panel to a different position on the mounting rack.

2. The fiber panel of claim 1, wherein the fiber connection portion comprises an adapter that is structurally configured to receive fiber connectors.

3. The fiber panel of claim 1, wherein the fiber connection portion comprises a splice area that is structurally configured to hold fiber splices.

4. The fiber panel of claim 1, wherein the cable storage portion comprises a base and a wall extending from the base.

5. The fiber panel of claim 4, wherein the base, the wall, and a portion of the body portion form an enclosure.

6. The fiber panel of claim 1, wherein the cable management portion comprises a partition that is structurally configured to receive the additional slack length of the fiber optic cable.

7. The fiber panel of claim 1, wherein the connector holding portion is structurally configured to hold a plurality of connectors that are connected to optical fibers contained in the fiber optic cable.

8. The fiber panel of claim 7, wherein the optical fibers are optically connected to the connectors.

9. A fiber cable distribution panel with covered cable storage and splice or adapter area structurally configured to provide different panel configurations during operation, comprising:
a main portion configured to be coupled with a mounting rack;
a cable storage portion structurally configured to be coupled with the main portion;
a cable management portion configured to be located in an interior of the cable storage portion;
a fiber connection portion configured to be located in the interior of the cable storge portion;
wherein the cable storage portion is structurally configured to move relative to the main portion between a closed position and an open position;
wherein the cable management portion is structurally configured to receive a slack length of a fiber optic input cable;
wherein the fiber connection portion is at least partially enclosed by the main portion and the cable storage portion when the cable storage portion is in the closed position;
wherein the cable storage portion comprises a fiber connector portion that is structurally configured to optically couple an output fiber from the fiber connection portion with a fiber cable external to the fiber cable distribution panel; and
wherein the body portion and the cable storage portion are configured to permit the cable management portion to receive an additional slack length of the fiber optic input cable or allow pay out of a portion of the slack length of the fiber optic input cable while the fiber optic input cable is coupled with the fiber connection portion so as to provide slack cable storage in the interior of the pivoting portion when relocating of the panel to a different position on the mounting rack.

10. The fiber panel of claim 9, wherein the cable storage portion is configured to pivot relative to the main portion between the closed position and the open position.

11. The fiber panel of claim 9, wherein the fiber connection portion comprises an adapter that is structurally configured to receive fiber connectors.

12. The fiber panel of claim 9, wherein the fiber connection portion comprises a splice area that is structurally configured to hold fiber splices.

13. The fiber panel of claim 9, wherein the cable storage portion comprises a base and a wall extending from the base.

14. The fiber panel of claim 13, wherein the base, the wall, and a portion of the main portion form an enclosure.

15. The fiber panel of claim 9, wherein the cable management portion comprises a partition that is structurally configured to receive the additional slack length of the fiber optic cable.

16. The fiber panel of claim 9, wherein the connector holding portion is structurally configured to hold a plurality of connectors that are connected to optical fibers contained in the fiber optic cable.

17. The fiber panel of claim 16, wherein the optical fibers are optically connected to the connectors.

18. A fiber cable distribution panel with covered cable storage and splice or adapter area structurally configured to provide different panel configurations during operation, comprising:
a main portion configured to be coupled with a mounting rack;
a cable storage portion structurally configured to be coupled with the main portion;
a cable management portion configured to be at least partially located in an interior of the cable storage portion;
a fiber connection portion configured to be at least partially located in the interior of the cable storage portion; and
wherein the body portion and the cable storage portion are configured to permit the cable management portion to receive an additional slack length of a fiber optic input cable or allow pay out of a portion of a slack length of the fiber optic input cable while the fiber optic input cable is coupled with the fiber connection portion so as to provide slack cable storage in the interior of the cable storage portion when relocating of the panel to a different position on the mounting rack.

19. The fiber panel of claim 18, wherein the cable storage portion is configured to move relative to the main portion between the closed position and an open position.

20. The fiber panel of claim 19, wherein the cable storage portion is configured to pivot relative to the main portion between the closed position and the open position.

21. The fiber panel of claim 18, wherein the fiber connection portion comprises an adapter that is structurally configured to receive fiber connectors.

22. The fiber panel of claim 18, wherein the fiber connection portion comprises a splice area that is structurally configured to hold fiber splices.

23. The fiber panel of claim 18, wherein the cable storage portion comprises a base and a wall extending from the base, and the base, the wall, and a portion of the main portion form an enclosure.

24. The fiber panel of claim 18, wherein optical fibers of the fiber optic cable are optically connected to the connectors.

25. The fiber panel of claim 18, wherein the cable management portion and the fiber connection portion are at least partially enclosed by the main portion and the cable storage portion when the cable storage portion is in a closed position.
